(19) United States
(12) Patent Application Publication
(10) Pub. No.: US 2025/0219876 A1
(43) Pub. Date: Jul. 3, 2025

(54) RECEIVER FOR ADJUSTING LOG LIKELIHOOD RATIO AND METHOD OF OPERATING THE SAME

(71) Applicant: Samsung Electronics Co., Ltd., Suwon-si (KR)

(72) Inventors: Joohan KIM, Suwon-si (KR); Junyeong SEO, Suwon-si (KR); Youngseok JUNG, Suwon-si (KR)

(73) Assignee: Samsung Electronics Co., Ltd., Suwon-si (KR)

(21) Appl. No.: 18/985,615

(22) Filed: Dec. 18, 2024

(30) Foreign Application Priority Data
Dec. 28, 2023 (KR) 10-2023-0195352

(51) Int. Cl. H04L 25/03; H04B 7/08

(52) U.S. Cl. CPC H04L 25/03318; H04B 7/0854

(57) ABSTRACT

Provided is a receiver for receiving a signal including a symbol, the receiver including processing circuitry configured to generate a first log likelihood ratio corresponding to a bit included in the symbol based on a first log likelihood ratio calculation method, the first log likelihood ratio calculation method being a linear calculation method, generate a second log likelihood ratio corresponding to the bit based on a second log likelihood ratio calculation method, the second log likelihood ratio calculation method being a nonlinear calculation method, generate comparison data based on a result of comparing the first log likelihood ratio with the second log likelihood ratio, and generate a final log likelihood ratio corresponding to at least one of the first log likelihood ratio or the second log likelihood ratio based on the comparison data.

### CROSS-REFERENCE TO RELATED APPLICATION

This application is based on and claims priority under 35 U.S.C. § 119 to Korean Patent Application No. 10-2023-0195352, filed on Dec. 28, 2023, in the Korean Intellectual Property Office, the disclosure of which is incorporated by reference herein in its entirety.

### BACKGROUND

The inventive concepts relate to a receiver and a method of operating the receiver, and more particularly, to a receiver including a detector for adjusting a log likelihood ratio and a method of operating the receiver.

With the recent rapid development of wired and wireless communication technology, and smart device-related technologies, research is being performed to increase decoding accuracy for signals received by receivers in wireless communication systems.

In general, a receiver may receive an encoded signal from a transmitter, decode the received signal, and obtain information transmitted by the transmitter. To decode the received signal, the receiver may generate a log likelihood ratio. The log likelihood ratio may mean a probability in which the received signal is decoded to 0 or 1. The received signal may be decoded to 0 or 1 according to the sign of the log likelihood ratio. If the log likelihood ratio is miscalculated, the decoding reliability may be lowered.

### SUMMARY

The inventive concepts provide a receiver and a method of operating the receiver, which is capable of more accurately decoding a received signal by adjusting a log likelihood ratio. According to embodiments, a method of adjusting the log likelihood ratio is provided to perform accurate decoding.

The technical tasks of the present disclosure are not limited to the technical tasks described above, and other technical tasks not mentioned may be clearly understood by a person skilled in the art from the following description.

According to an aspect of the inventive concepts, there is provided a receiver for receiving a signal including a symbol, the receiver including processing circuitry configured to generate a first log likelihood ratio corresponding to a bit included in the symbol based on a first log likelihood ratio calculation method, the first log likelihood ratio calculation method being a linear calculation method, generate a second log likelihood ratio corresponding to the bit based on a second log likelihood ratio calculation method, the second log likelihood ratio calculation method being a nonlinear calculation method, generate comparison data based on a result of comparing the first log likelihood ratio with the second log likelihood ratio, and generate a final log likelihood ratio corresponding to at least one of the first log likelihood ratio or the second log likelihood ratio based on the comparison data.

According to an aspect of the inventive concepts, there is provided a method of operating a receiver, the method including generating a first log likelihood ratio corresponding to a bit based on a first log likelihood ratio calculation method, the bit being included in a symbol of a received signal, generating a second log likelihood ratio corresponding to the bit based on a second log likelihood ratio calculation method, comparing the first log likelihood ratio with the second log likelihood ratio to obtain a comparison result, and generating a final log likelihood ratio corresponding to at least one of the first log likelihood ratio or the second log likelihood ratio based on the comparison result.

According to an aspect of the inventive concepts, there is provided a receiver for receiving a signal including a symbol, the receiver including processing circuitry configured to generate a first log likelihood ratio and a second log likelihood ratio corresponding to a bit included in a symbol, the first log likelihood ratio and the second log likelihood ratio being generated based on two different log likelihood ratio calculation methods, and generate a final log likelihood ratio corresponding to at least one of the first log likelihood ratio or the second log likelihood ratio based on a result of comparing the first log likelihood ratio with the second log likelihood ratio, and decode the symbol based on the final log likelihood ratio.

### BRIEF DESCRIPTION OF THE DRAWINGS

Embodiments of the inventive concepts will be more clearly understood from the following detailed description taken in conjunction with the accompanying drawings in which:

FIG. 1 is a block diagram illustrating a communication system according to embodiments;

FIG. 2 is a block diagram illustrating a transmitter according to embodiments;

FIG. 3 is a block diagram illustrating a receiver according to embodiments;

FIG. 4 is a block diagram illustrating an adjustment detector according to embodiments;

FIG. 5 is a block diagram illustrating an adjustment detector according to embodiments;

FIG. 6 is a flowchart illustrating a method of operating a receiver, according to embodiments;

FIG. 7 is a flowchart illustrating a method of operating a receiver, according to embodiments;

FIG. 8 is a flowchart illustrating a method of operating a receiver, according to embodiments; and

FIG. 9 is a block diagram illustrating a wireless communication device according to embodiments.

### DETAILED DESCRIPTION

Hereinafter, embodiments of the inventive concepts will be described in detail with reference to the accompanying drawings.

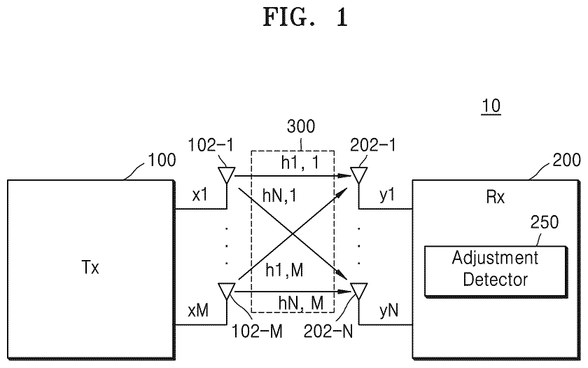

FIG. 1 is a block diagram illustrating a communication system according to embodiments. Referring to FIG. 1, a communication system 10 may include a transmitter 100 and a receiver 200 for wireless communication through a multiple-input and multiple-output (MIMO) channel 300.

The system 10 may be any system including the MIMO channel 300. In embodiments, the system 10 may be a wireless communication system such as a 5th generation (5G) wireless system, a Long Term Evolution (LTE) system, wireless fidelity (WiFi), or the like as non-limiting examples. In embodiments, the system 10 may be a wired communication system such as a storage system, a network system, or the like. Hereinafter, the system 10 will be mainly described with reference to a wireless communication system, but embodiments of the inventive concepts are not limited thereto.

For example, the transmitter 100 may be a base station or a component included in the base station. The base station may refer to a fixed station that communicates with terminals and/or other base stations and may transmit/receive data and/or control information by communicating with the terminals and/or the other base stations. The base station may also be referred to as a Node B, an evolved-Node B (eNB), a Base Transceiver System (BTS), an Access Point (AP), or the like.

For example, the receiver 200 may be a terminal or a component included in the terminal. The terminal is a wireless communication device and may refer to various devices capable of transmitting/receiving data and/or control information to/from the transmitter 100 by communicating with the transmitter 100. For example, the terminal may be referred to as user equipment, a mobile station (MS), a mobile terminal (MT), a user terminal (UT), a subscriber station (SS), a wireless device, a portable device, or the like.

A wireless communication network between the transmitter 100 and the receiver 200 may support multiple users to communicate with each other by sharing available network resources. For example, in wireless communication networks, information may be transmitted in a variety of ways, such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA).

The transmitter 100 includes a plurality of transmission antennas 102-1 to 102-M (hereinafter, M is a positive integer) and may transmit a plurality of symbols x1 to xM through the plurality of transmission antennas 102-1 to 102-M, respectively. In addition, the receiver 200 has a plurality of reception antennas 202-1 to 202-N (hereinafter, N is a positive integer) and may receive a plurality of symbols y1 to yN through the plurality of reception antennas 202-1 to 202-N, respectively.

For example, when the symbol vector transmitted from the transmitter 100 is expressed as x=[x1, . . . xM]^{T}, the symbol vector y received at the receiver 200 may be expressed by Equation 1 below.

$$y = Hx + n = ( \begin{matrix}h 1 , 1 & … & h 1 , M \\ ⋮ & ⋱ & ⋮ \\ hN , 1 & … & hN , M\end{matrix} ) ( \begin{matrix}x 1 \\ ⋮ \\ xM\end{matrix} ) + ( \begin{matrix}n 1 \\ ⋮ \\ nN\end{matrix} ) \qquad [ Equation 1 ]$$

In Equation 1, hi, j represents an effective channel gain between the j-th (where j is an integer from 1 to M) transmission antenna (or transmission layer) and the i-th (where i is an integer from 1 to N) reception antenna, and xj included in the symbol vector transmitted from the transmitter 100 represents a transmission symbol from the j-th transmission antenna (or transmission layer).

The transmission symbol xj may be one of signal constellation points. A constellation point may mean a point on a complex plane used by the transmitter 100 to map a transmission signal. The number and positions of constellation points on the complex plane may differ according to a modulation method of the transmission signal. For example, when the transmitter 100 modulates a transmission signal using a Quadrature Phase Shift Keying (QPSK) method, one constellation point may be located in each quadrant of the complex plane. That is, four constellation points may be used for modulation of a transmission signal. The transmitter 100 that modulates the transmission signal using the QPSK method may map the transmission signal to one of the four constellation points and transmit the transmission signal to the receiver 200. For convenience of explanation, the modulation method of the transmitter 100 is described on the assumption that the modulation method of the transmitter 100 is a QPSK method. However, the modulation method of the transmitter 100 is not limited thereto, and it may be easily understood that the transmission signal may be modulated using 16 quadrature amplitude modulation (16QAM), 64QAM, 256QAM, and 1024QAM methods.

In addition, in Equation 1, ni included in the noise vector n represents additive white Gaussian noise (AWGN) from the i-th reception antenna, and ni may have power (or variance) of @. The AWGN may also include an interference signal. As an example, the noise of a reception antenna in the communication system 10 may be considered together with the influence of the interference signal. In this case, the variance of the AWGN to each of the plurality of reception antennas 202-1 to 202-N may be different and spatially correlated, and it is assumed hereinafter that the power of the AWGN is the same (or similar) and spatially uncorrelated for each reception antenna. In this case, the AWGN may be the same as (or similar to) the noise to which a whitening filter is applied.

The receiver 200 may include an adjustment detector 250. The adjustment detector 250 may generate a Log Likelihood Ratio corresponding to each bit corresponding to the received signal (e.g., each bit of the received signal). The receiver 200 may estimate a corresponding bit based on the log likelihood ratio. For example, if the log likelihood ratio is positive, the corresponding bit may be estimated to be “1” out of “1” and “0”, and if the log likelihood ratio is negative, the corresponding bit may be estimated to be “0”. The log likelihood ratio may refer to a value indicating the probability in which the received signal is decoded to “0” or “1”. When the magnitude of the log likelihood ratio is greater than a preset (or alternatively, given) threshold value, the receiver 200 may perform decoding on the received signal based on the log likelihood ratio. For example, if the preset (or alternatively, given) threshold value is 50 and the log likelihood ratio is 70, the receiver 200 may decode the bit of the received signal to 1, and if the log likelihood ratio is −65, the receiver 200 may decode the bit of the received signal to 0.

The log likelihood ratio may be calculated based on a Euclidean distance. Specifically, the adjustment detector 250 may calculate a Euclidean distance between a plurality of candidate points and the received signal, and may calculate a log likelihood ratio based on the Euclidean distance. The plurality of candidate points may be determined according to a modulation method of the transmitter 100. For example, if the transmitter 100 modulates the transmission signal using a QPSK method and symbols are transmitted from two transmission antennas to one reception antenna, there may be 16 candidate points. The adjustment detector 250 may calculate a log likelihood ratio based on a Euclidean distance between the plurality of candidate points and the received symbol. For example, the log likelihood ratio may be negative if the Euclidean distance between the candidate points corresponding to 0 among the plurality of candidate points and the received symbol is less than the Euclidean distance between the candidate points corresponding to 1 and the received symbol. The adjustment detector 250 may generate a log likelihood ratio for the received signal and provide the generated log likelihood ratio to a decoder. The decoder may decode the received signal based on the log likelihood ratio received from the adjustment detector 250.

The adjustment detector 250 according to embodiments may generate two log likelihood ratios through two different log likelihood ratio calculation methods. As described above, when the signs of two log likelihood ratios corresponding to the same received signal (or similar received signals) are different, the decoding reliability may be lower. Therefore, the adjustment detector according to embodiments may generate a final log likelihood ratio by comparing the two log likelihood ratios, thereby improving the decoding performance of the receiver.

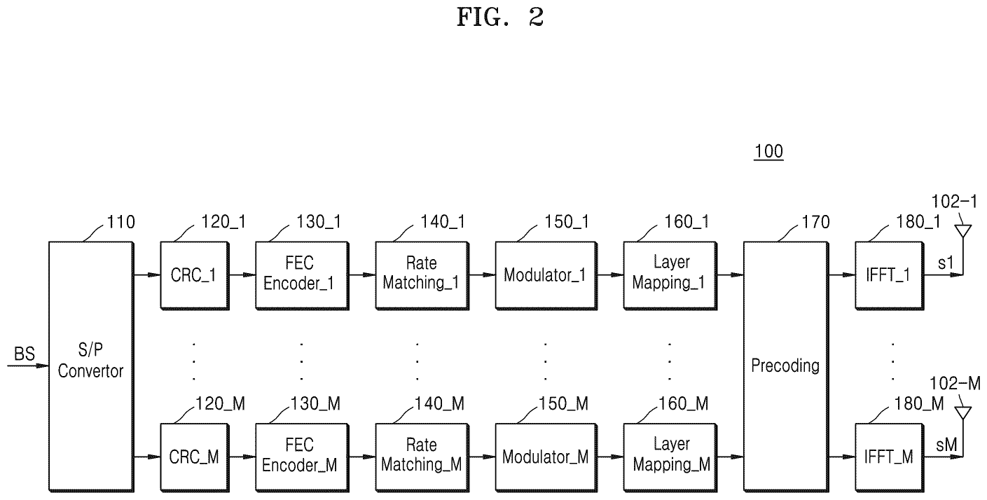

FIG. 2 is a block diagram illustrating a transmitter according to embodiments.

FIG. 2 may show, for example, configurations included in the transmitter 100 of FIG. 1.

Referring to FIG. 2, the transmitter 100 may include a serial to parallel convertor (S/P) convertor 110, multiple cyclic redundancy check (CRC) units 120_1 to 120_M, multiple forward error correction (FEC) encoders 130_1 to 130_M, multiple rate matching units 140_1 to 140_M, multiple modulators 150_1 to 150_M, multiple layer mapping units 160_1 to 160_M, a precoding unit 170, multiple inverse fast Fourier transform (IFFT) units 180_1 to 180_M, and/or multiple antennas 102-1 to 102-M.

First, an information bitstream BS, which is a transmission target, may be input to the S/P convertor 110. The S/P convertor 110 may generate a plurality of information bitstreams by converting the input information bitstream BS in parallel, and output the input information bitstream BS to the CRC units 120_1 to 120_M, respectively. For example, the S/P convertor 110 may convert the information bitstream BS into a codeword (or transport block), which is a channel decoding input unit, and output the codeword in parallel.

The plurality of CRC units 120_1 to 120_M may perform a CRC check operation on the parallel-converted bitstreams, respectively, and output the signal on which the CRC check has been performed to the FEC encoders 130_1 to 130_M, respectively. For example, the plurality of CRC units 120_1 to 120_M may perform CRC for error detection occurring during the transmission process.

For signals received from the plurality of CRC units 120_1 to 120_M, the plurality of FEC encoders 130_1 to 130_M may use FEC, which is an error correction code for correcting an error caused by noise. For example, in a wireless communication system, at least one of a convolution code, a turbo code, a low-density parity check (LDPC) code, and/or a polar code may be used in FEC.

The plurality of rate matching units 140_1 to 140_M may perform a rate matching operation based on a preset (or alternatively, given) rate matching method for signals output from the plurality of FEC encoders 130_1 to 130_M, and output, to the plurality of modulators 150_1 to 150_M, the signals on which the rate matching operation has been performed. Through the rate matching operation, the plurality of rate matching units 140_1 to 140_M may match the encoded bits with the number of modulation symbols assigned to each user.

The plurality of modulators 150_1 to 150_M may perform a modulation operation on the rate-matched signals based on a preset (or alternatively, given) modulation method, and output the modulated signals to the plurality of layer mapping units 160_1 to 160_M, respectively. For example, the plurality of modulators 150_1 to 150_M may map rate-matched signals to signal constellation points. The plurality of layer mapping units 160_1 to 160_M may distribute the modulated signals to match the number of input layers of the precoding unit 170.

The precoding unit 170 may perform a precoding operation based on a preset (or alternatively, given) precoding method on signals output from each of the layer mapping units 160_1 to 160_M, and output the precoded signals to the IFFT units 180_1 to 180_M. For example, the precoding method may be generated based on the feedback information received by the transmitter 100. The plurality of IFFT units 180_1 to 180_M may convert a transmission signal for each transmission antenna of a frequency domain output from the precoding unit 170 into a time domain through IFFT, and transmit the converted transmission signals s1 to sM to the antennas 102-1 to 102-M.

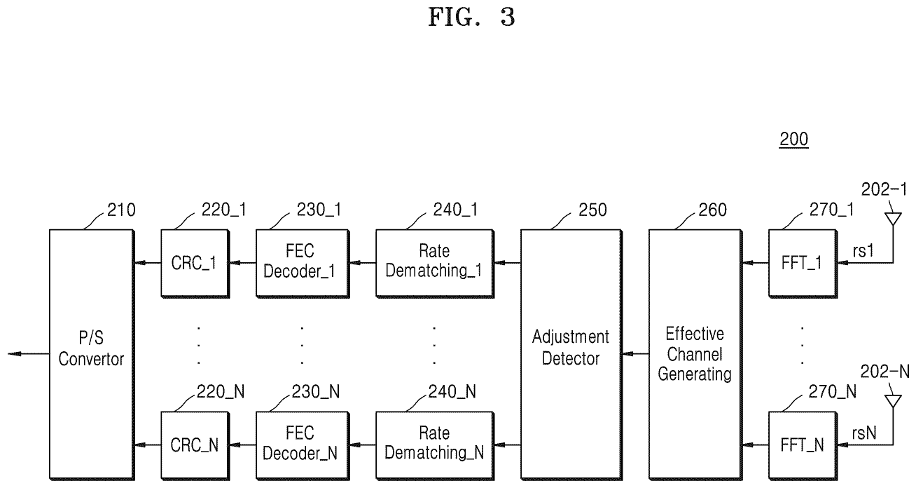

FIG. 3 is a block diagram illustrating a receiver according to embodiments.

FIG. 3 may be, for example, a block diagram of components included in the receiver 200 of FIG. 1.

Referring to FIG. 3, the receiver 200 may include a plurality of antennas 202-1 to 202-N, a plurality of fast Fourier transform (FFT) units 270_1 to 270_N, an effective channel generating unit 260, an adjustment detector 250, a plurality of rate dematching units 240_1 to 240_N, a plurality of FEC decoders 230_1 to 230_N, a plurality of CRC units 220_1 to 220_N, and/or a parallel to serial (P/S) convertor 210.

First, signals rs1 to rsN received through the plurality of antennas 202-1 to 202-N are input to the plurality of FFT units 270_1 to 270_N, respectively, and the plurality of FFT units 270_1 to 270_N may perform an FFT operation on the signals rs1 to rsN. That is, the plurality of FFT units 270_1 to 270_N may convert the received signal for each antenna of the time domain into the frequency domain through the FFT, and transmit the converted received signal to the effective channel generating unit 260.

The effective channel generating unit 260 may reflect the influence of the precoding method applied by the transmitter 100 on the received signals rs1 to rsM converted to the frequency domain, and output the reflection result to the adjustment detector 250. In the present example, the receiver 200 is provided with the effective channel generating unit 260 to reflect the influence of the precoding method applied by the transmitter 100, but in embodiments, the receiver 200 may not include the effective channel generating unit 260. For example, when precoding is also applied to a reference signal, the receiver 200 may not include the effective channel generating unit 260.

The adjustment detector 250 may perform a demodulation operation on the signal output from the effective channel generating unit 260 based on a demodulation method corresponding to the modulation method used by the transmitter 100. For example, the adjustment detector 250 may generate a log likelihood ratio using the effective channel and received signals rs1 to rsN generated from the effective channel generating unit 260.

The adjustment detector 250 according to embodiments may include at least two detectors, and a plurality of log likelihood ratios may be calculated based on different log likelihood ratio calculation methods through at least two detectors. The adjustment detector 250 may calculate a log likelihood ratio based on log likelihood calculation methods of at least two of minimum mean square error (MMSE), minimum likelihood (ML), near ML, zero forcing (ZF), k-best, and/or sphere. The adjustment detector 250 may compare at least two log likelihood ratios to generate a final log likelihood ratio corresponding to the received signal.

The receiver according to embodiments may more accurately decode the received signal by generating a final log likelihood ratio based on at least two log likelihood ratios.

The plurality of rate dematching units 240_1 to 240_N may perform a rate dematching operation based on a rate dematching method corresponding to the rate matching method used by the transmitter 100 with respect to the signal output from the adjustment detector 250. The FEC decoders 230_1 to 230_N may perform a decoding operation on the signals output from the rate dematching units 240_1 to 240_N based on the FEC decoding method corresponding to the FEC encoding method used by the transmitter 100. The FEC decoders 230_1 to 230_N according to embodiments may decode the received signal based on the final log likelihood ratio provided from the adjustment detector 250.

The CRC units 220_1 to 220_N may perform a CRC check operation on signals output from the FEC decoders 230_1 to 230_N, and output, to the P/S convertor 210, the signal on which the CRC check has been performed. The P/S convertor 210 may serially convert signals output from the CRC units 220_1 to 220_N and output the serially converted signals. According to embodiments, after recovering the serially converted signals, the receiver 200 may perform one or more further operation(s) based on the serially converted signals. For example, the one or more further operation(s) may include one or more of providing the serially converted signals to an application executing on the receiver 200 (e.g., for performing a service based on data provided in the serially converted signals), storing the serially converted signals, sending a response signal to the transmitter 100 (e.g., using the same components as, or similar components to, those discussed in connection with FIG. 2) based on data provided in the serially converted signals, etc.

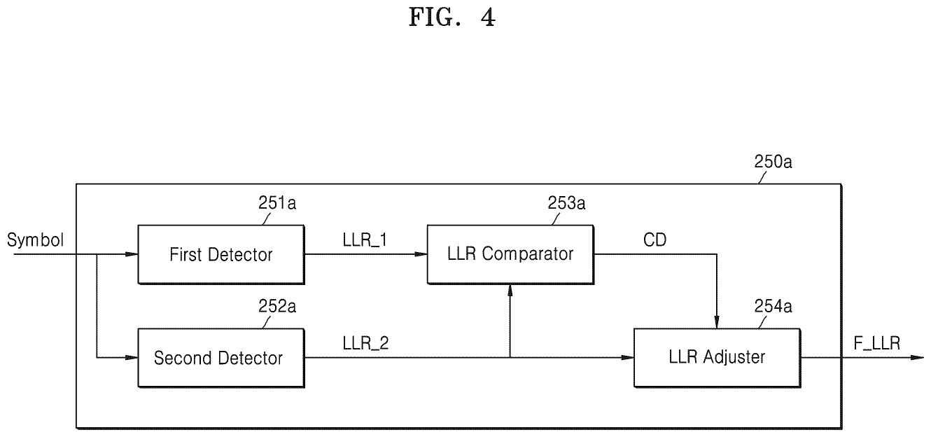

FIG. 4 is a block diagram illustrating an adjustment detector according to embodiments.

An adjustment detector 250a of FIG. 4 may correspond to the adjustment detector 250 described above with reference to FIG. 3. Therefore, redundant descriptions are omitted.

Referring to FIG. 4, the adjustment detector 250a may include a first detector 251a, a second detector 252a, a log likelihood ratio comparator 253a, and/or a log likelihood ratio adjuster 254a. The adjustment detector 250a of FIG. 4 may receive a symbol included in the received signal from the effective channel generating unit 260 of FIG. 3. The symbol may be represented by a plurality of bits. The adjustment detector 250a may calculate a log likelihood ratio for each of the plurality of bits included in the symbol. As described above, the receiver may decode the corresponding bit to 0 or 1 according to the sign of the log likelihood ratio.

The first detector 251a according to embodiments may generate the first log likelihood ratio LLR_1 based on a first log likelihood ratio calculation method. For example, the first detector 251a may calculate the first log likelihood ratio LLR_1 corresponding to the bits included in the symbol based on MMSE. The first detector 251a according to embodiments may be a linear detector that calculates a log likelihood ratio based on a linear calculation method such as ZF and MMSE.

The second detector 252a according to embodiments may generate the second log likelihood ratio LLR_2 based on a second log likelihood ratio calculation method different from the first log likelihood ratio calculation method. For example, the second detector 252a may calculate the second log likelihood ratio LLR_2 based on ML or near ML. The second detector 252a according to embodiments may be a nonlinear detector that calculates a log likelihood ratio based on a nonlinear calculation method such as ML or near ML.

As described above, one of the two detectors included in the adjustment detector 250a was described as a linear detector and the other a nonlinear detector. However, the adjustment detector 250a according to embodiments is not limited thereto, and both detectors may be linear detectors or nonlinear detectors. In addition, the first detector 251a may be a nonlinear detector, and the second detector 252a may be a linear detector. However, methods of calculating the log likelihood ratio by two detectors according to embodiments may be different from each other. For example, the first detector 251a may calculate the first log likelihood ratio LLR_1 based on ZF and the second detector 252a may calculate the second log likelihood ratio LLR_2 based on MMSE. In another example, the first detector 251a may calculate the first log likelihood ratio LLR_1 based on ML and the second detector 252a may calculate the second log likelihood ratio LLR_2 based on near ML.

The log likelihood ratio comparator 253a according to embodiments may receive the first log likelihood ratio LLR_1 and the second log likelihood ratio LLR_2. The log likelihood ratio comparator 253a may compare the first log likelihood ratio LLR_1 with the second log likelihood ratio LLR_2 to generate comparison data CD.

The log likelihood ratio comparator 253a according to embodiments may generate comparison data CD by comparing the sign of the first log likelihood ratio LLR_1 with the sign of the second log likelihood ratio LLR_2. For example, when the sign of the first log likelihood ratio LLR_1 is the same as (or similar to) the sign of the second log likelihood ratio LLR_2, the comparison data CD may be 0. When the sign of the first log likelihood ratio LLR_1 is different from the sign of the second log likelihood ratio LLR_2, the comparison data CD may be 1.

The log likelihood ratio comparator 253a according to embodiments may compare the sign of the first log likelihood ratio LLR_1 with the sign of the second log likelihood ratio LLR_2, and further compare the magnitude of the first log likelihood ratio LLR_1 with the magnitude of the second log likelihood ratio LLR_2 to generate comparison data CD. When the sign of the first log likelihood ratio LLR_1 and the sign of the second log likelihood ratio LLR_2 are the same (or similar), the log likelihood ratio comparator 253a may compare the magnitude of the first log likelihood ratio LLR_1 with the magnitude of the second log likelihood ratio LLR_2 to generate comparison data CD. For example, when the magnitude of the first log likelihood ratio LLR_1 is greater than the magnitude of the second log likelihood ratio LLR_2, the comparison data may be 00. When the magnitude of the first log likelihood ratio LLR_1 is less than the magnitude of the second log likelihood ratio LLR_2, the comparison data may be 01. The examples described above are for convenience of description, and embodiments according to the inventive concepts are not limited thereto. According to embodiments, the log likelihood ratio comparator 253a may generate the comparison data CD to include a difference between the magnitude of the first log likelihood ratio LLR_1 and the magnitude of the second log likelihood ratio LLR_2.

The log likelihood ratio adjuster 254a according to embodiments may receive the comparison data CD. In addition, the log likelihood ratio adjuster 254a may receive the second log likelihood ratio LLR_2. The log likelihood ratio adjuster 254a may generate the final log likelihood ratio F_LLR by adjusting the second log likelihood ratio LLR_2 based on the comparison data CD. For example, the log likelihood ratio adjuster 254a according to embodiments may generate the final log likelihood ratio F_LLR by applying an adjustment value to the second log likelihood ratio LLR_2. The adjustment value is a positive real number less than 1. The log likelihood ratio adjuster 254a may generate the final log likelihood ratio F_LLR by multiplying the second log likelihood ratio LLR_2 by an adjustment value. The adjustment value according to embodiments may have a smaller value as the difference between the first log likelihood ratio LLR_1 and the second log likelihood ratio LLR_2 increases. The log likelihood ratio adjuster 254a may generate a final log likelihood ratio F_LLR having a relatively smaller magnitude by using an adjustment value having a smaller value as the difference between the first log likelihood ratio LLR_1 and the second log likelihood ratio LLR_2 increases. Examples discussed in connection with FIG. 4 involve the log likelihood ratio adjuster 254a receiving the second log likelihood ratio LLR_2 without receiving the first log likelihood ratio LLR_1, but embodiments are not limited thereto. According to embodiments, the log likelihood ratio adjuster 254a may receive the first log likelihood ratio LLR_1 without receiving the second log likelihood ratio LLR_2. In such examples, the log likelihood ratio adjuster 254a may generate the final log likelihood ratio F_LLR by applying an adjustment value to the second log likelihood ratio LLR_2. According to embodiments, the log likelihood ratio adjuster 254a may generate the final log likelihood ratio F_LLR to be (e.g., have a value equal to that of) the second log likelihood ratio LLR_2 (or the first log likelihood ratio LLR_1) without applying the adjustment value (or by applying an adjustment value of 1).

The operation for generating the second log likelihood ratio LLR_2 of the second detector 252a may include an operation for generating the first log likelihood ratio LLR_1 of the first detector 251a. Accordingly, the second detector 252a may receive the operation result of the first detector 251a and minimize (or reduce) the duplicate operation to generate the second log likelihood ratio LLR_2. Accordingly, the overall computational amount or complexity of the adjustment detector 250a may be reduced. That is, the second log likelihood ratio calculation method may calculate the second log likelihood ratio LLR_2 based on the calculation result according to the first log likelihood ratio calculation method. For example, the first log likelihood ratio calculation method may be a method of calculating the first log likelihood ratio LLR_1 based on the MMSE, and the second log likelihood ratio calculation method may calculate the second log likelihood ratio LLR_2 based on the prior operation of the MMSE. For example, when the first log likelihood ratio calculation method is based on MMSE, the second log likelihood ratio calculation method may generate the second log likelihood ratio LLR_2 based on any one of near ML, k-best, and sphere.

The adjustment detector 250a may provide the final log likelihood ratio F_LLR to the decoder (the FEC decoder in FIG. 3). The receiver may decode the received signal based on the final log likelihood ratio F_LLR. The adjustment detector 250a generates a final log likelihood ratio based on at least two log likelihood ratios generated by at least two different calculation methods, thereby improving the decoding performance of the receiver according to the inventive concepts. According to embodiments, the receiver may decode the received signal based on the final log likelihood ratio F_LLR including comparing the final log likelihood ratio F_LLR to a preset (or alternatively, given) threshold value as discussed in connection with FIG. 1.

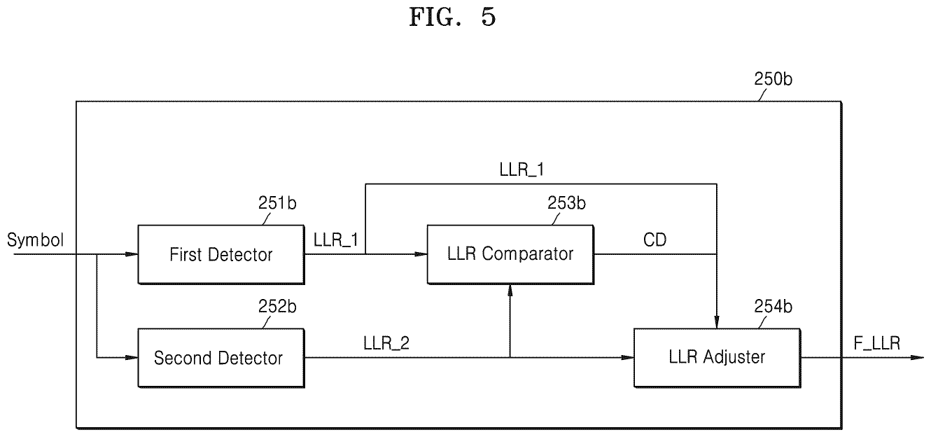

FIG. 5 is a block diagram illustrating an adjustment detector according to embodiments.

An adjustment detector 250b of FIG. 5 may correspond to the adjustment detector 250 described above with reference to FIG. 3. Therefore, redundant descriptions are omitted.

Referring to FIG. 5, the adjustment detector 250b may include a first detector 251b, a second detector 252b, a log likelihood ratio comparator 253b, and/or a log likelihood ratio adjuster 254b. The first detector 251b and the second detector 252b may calculate a first log likelihood ratio LLR_1 and a second log likelihood ratio LLR_2, respectively.

The log likelihood ratio comparator 253b according to embodiments may compare the first log likelihood ratio LLR_1 with the second log likelihood ratio LLR_2. The receiver according to embodiments may generate a final log likelihood ratio based on a result of comparing the first log likelihood ratio LLR_1 with the second log likelihood ratio LLR_2.

The log likelihood ratio adjuster 254b may receive the comparison data CD and the first log likelihood ratio LLR_1. The log likelihood ratio adjuster 254b may further receive the second log likelihood ratio LLR_2. The log likelihood ratio adjuster 254b may generate a final log likelihood ratio F_LLR based on the comparison data CD, the first log likelihood ratio LLR_1, and the second log likelihood ratio LLR_2.

When the sign of the first log likelihood ratio LLR_1 and the sign of the second log likelihood ratio LLR_2 are the same (or similar), the log likelihood ratio adjuster 254b according to embodiments may provide a decoder with a larger log likelihood ratio between (e.g., among) the first log likelihood ratio LLR_1 and the second log likelihood ratio LLR_2 as the final log likelihood ratio F_LLR. For example, the log likelihood ratio adjuster 254b may provide the decoder with the first log likelihood ratio LLR_1 based on the first log likelihood ratio LLR_1 being larger than the second log likelihood ratio LLR_2 and the respective signs of the first log likelihood ratio LLR_1 and the second log likelihood ratio LLR_2 being the same (or similar). Also, the log likelihood ratio adjuster 254b may provide the decoder with the second log likelihood ratio LLR_2 based on the second log likelihood ratio LLR_2 being larger than the first log likelihood ratio LLR_1 and the respective signs of the first log likelihood ratio LLR_1 and the second log likelihood ratio LLR_2 being the same (or similar).

When the signs of at least two log likelihood ratios calculated through at least two different log likelihood ratio calculation methods are the same (or similar), the decoding reliability of the corresponding bit based on the log likelihood ratio is relatively high. For example, if each of the first log likelihood ratio LLR_1 and the second log likelihood ratio LLR_2 calculated based on different log likelihood ratio calculation methods is the same as (e.g., are both) “+”, the corresponding bit may be decoded to 1. Accordingly, the first log likelihood ratio LLR_1 and the second log likelihood ratio LLR_2 may not be adjusted, or may be relatively slightly adjusted, to generate the final log likelihood ratio F_LLR. According to embodiments, the final log likelihood ratio F_LLR may be adjusted to be larger than the larger log likelihood ratio between (e.g., among) the first log likelihood ratio LLR_1 and the second log likelihood ratio LLR_2 in response to determining the sign of the first log likelihood ratio LLR_1 and the sign of the second log likelihood ratio LLR_2 are the same (or similar).

When the sign of the first log likelihood ratio LLR_1 and the sign of the second log likelihood ratio LLR_2 are different from each other, the log likelihood ratio adjuster 254b according to embodiments may generate the final log likelihood ratio F_LLR based on the sum of the first log likelihood ratio LLR_1 and the second log likelihood ratio LLR_2. When the sign of the first log likelihood ratio LLR_1 and the sign of the second log likelihood ratio LLR_2 are different from each other, the log likelihood ratio adjuster 254b according to embodiments may provide a decoder with an average of the first log likelihood ratio LLR_1 and the second log likelihood ratio LLR_2 as the final log likelihood ratio F_LLR. When the sign of the first log likelihood ratio LLR_1 and the sign of the second log likelihood ratio LLR_2 are different from each other, the log likelihood ratio adjuster 254b according to embodiments may generate the final log likelihood ratio F_LLR by applying different weights to the first log likelihood ratio LLR_1 and the second log likelihood ratio LLR_2, respectively, and summing the weight-applied results. According to embodiments, the final log likelihood ratio F_LLR obtained from the summing operation, the averaging operation, and/or the weighted summing operation has a magnitude lower than each of the magnitudes of the first log likelihood ratio LLR_1 and the second log likelihood ratio LLR_2 (e.g., would have a magnitude between the first log likelihood ratio LLR_1 and the magnitude of the second log likelihood ratio LLR_2 in view of the differing signs).

When the signs of at least two log likelihood ratios calculated through at least two different log likelihood ratio calculation methods are different from each other, the decoding reliability of the corresponding bit based on the log likelihood ratio is relatively low. For example, when the sign of the first log likelihood ratio LLR_1 is “+” and the sign of the second log likelihood ratio LLR_2 is “−”, in which the first log likelihood ratio LLR_1 and the second log likelihood ratio LLR_2 are calculated based on different log likelihood ratio calculation methods, the corresponding bit is decoded to 1, considering the first log likelihood ratio LLR_1, but the corresponding bit is decoded to 0 considering the second log likelihood ratio LLR_2. Therefore, when the signs of at least two log likelihood ratios are different, the decoding reliability is lower. Accordingly, the adjustment detector 250b according to embodiments may generate a final log likelihood ratio F_LLR having a value between the first log likelihood ratio LLR_1 and the second log likelihood ratio LLR_2. That is, the adjustment detector 250b may generate the final log likelihood ratio F_LLR having a magnitude less than those of the first log likelihood ratio LLR_1 and the second log likelihood ratio LLR_2.

As described above, the receiver according to embodiments may improve decoding performance by generating a final log likelihood ratio F_LLR based on a log likelihood ratio having a large magnitude when the two log likelihood ratios have the same sign (or similar signs) and generating a final log likelihood ratio F_LLR having a smaller magnitude than the magnitude of each of the two log likelihood ratios when the signs thereof are different.

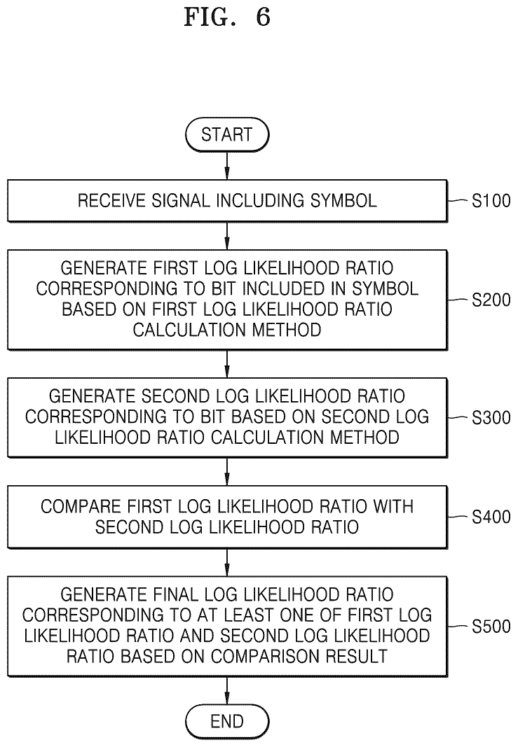

FIG. 6 is a flowchart illustrating a method of operating a receiver, according to embodiments.

Referring to FIG. 6, in operation S100, the receiver may receive a signal including a symbol.

In operation S200, the receiver may generate a first log likelihood ratio corresponding to a bit included in the symbol based on the first log likelihood ratio calculation method. For example, the first log likelihood ratio may be “10”.

In operation S300, the receiver may generate a second log likelihood ratio corresponding to the bit based on the second log likelihood ratio calculation method. The second log likelihood ratio may be “−7”. The first log likelihood ratio may be calculated based on the MMSE, and the second log likelihood ratio may be calculated based on the ML.

In operation S400, the receiver may compare the first log likelihood ratio with the second log likelihood ratio. As described above, the receiver may compare the signs and/or magnitudes of the first log likelihood ratio and the second log likelihood ratio with each other and may generate comparison data indicating a comparison result.

In operation S500, the receiver may generate a final log likelihood ratio corresponding to at least one of the first log likelihood ratio and/or the second log likelihood ratio based on the comparison result. As described above, the receiver may generate a final log likelihood ratio based on the comparison data indicating the comparison result. For example, when the sign of the first log likelihood ratio is different from the sign of the second log likelihood ratio, the receiver may generate a final log likelihood ratio by applying an adjustment value to either the first log likelihood ratio or the second log likelihood ratio. The applied adjustment value when the signs of the first and second log likelihood ratios are different, may be less than the applied adjustment value when the signs of the first and second log likelihood ratios are the same (or similar).

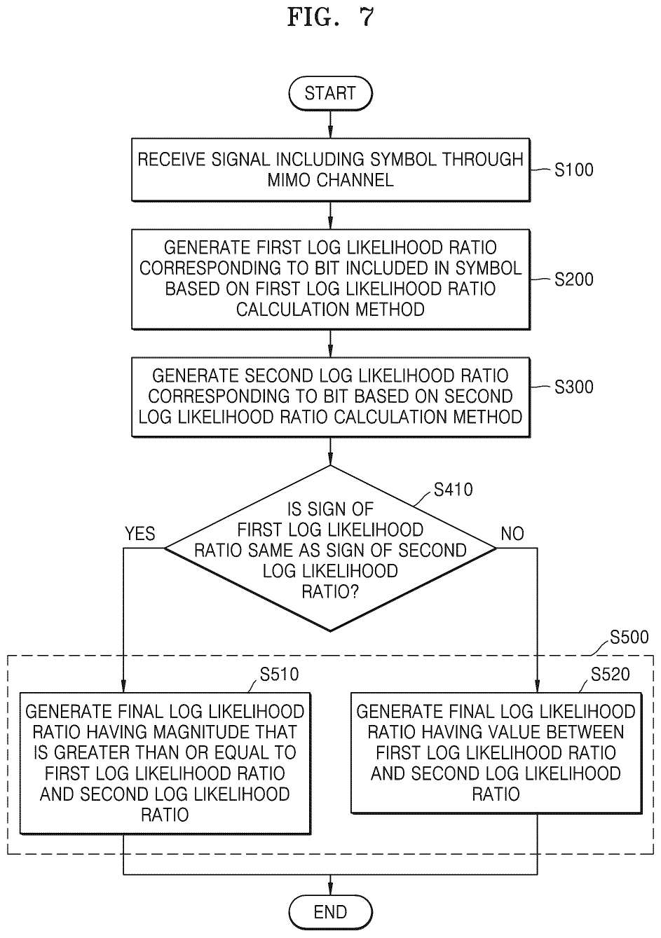

FIG. 7 is a flowchart illustrating a method of operating a receiver, according to embodiments.

FIG. 7 specifically illustrates operations S400 and S500 of FIG. 6. Descriptions of operations S100, S200, and S300 are redundant with the descriptions given above with reference to FIG. 6 and thus omitted.

Referring to FIG. 7, in operation S410, the receiver may determine whether the sign of the first log likelihood ratio is the same as (or similar to) the sign of the second log likelihood ratio.

In operation S510, the receiver may generate a final log likelihood ratio having a magnitude that is equal to or greater than (each of) the magnitude of the first log likelihood ratio and/or the magnitude of the second log likelihood ratio. When the sign of the first log likelihood ratio is the same as (or similar to) the sign of the second log likelihood ratio, the final log likelihood ratio may be a log likelihood ratio having a larger magnitude between (e.g., among those of) the first log likelihood ratio and the second log likelihood ratio.

In operation S520, the receiver may generate a final log likelihood ratio having a value between the first log likelihood ratio and the second log likelihood ratio. When the sign of the first log likelihood ratio is different from the sign of the second log likelihood ratio, the magnitude of the final log likelihood ratio may be less than (each of) the magnitude of the first log likelihood ratio and/or the magnitude of the second log likelihood ratio. According to embodiments, the final log likelihood ratio may be a value between the first log likelihood ratio and the second log likelihood ratio. For example, if the first log likelihood ratio is 10 and the second log likelihood ratio is −7, the final log likelihood ratio may be 1.5, which is the average of the first log likelihood ratio and the second log likelihood ratio. In another example, the final log likelihood ratio may be a value between −7 and 10.

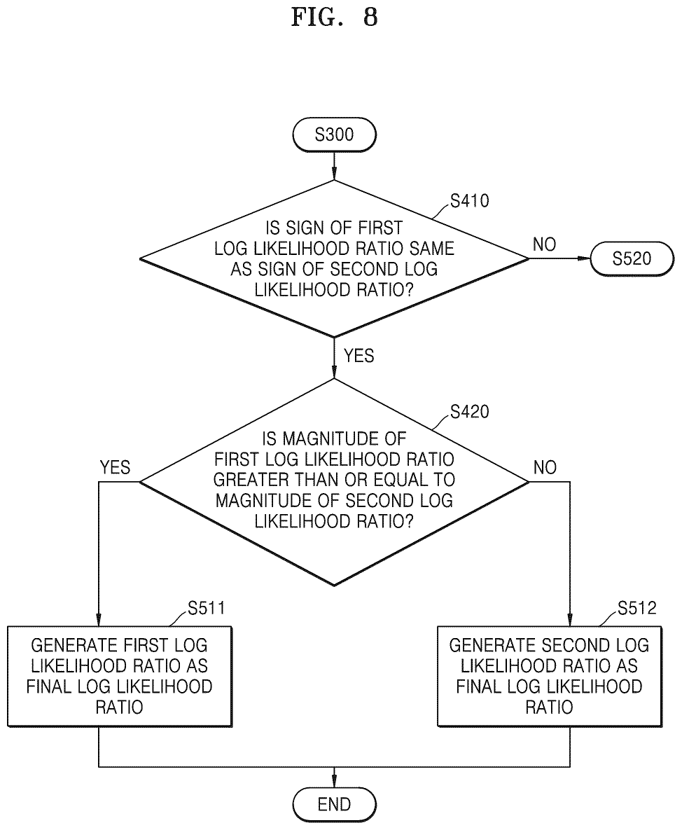

FIG. 8 is a flowchart illustrating a method of operating a receiver, according to embodiments.

FIG. 8 specifically illustrates operations S400 and S500 of FIG. 6. The description of operation S410 is redundant with the description given above with reference to FIG. 7 and thus omitted.

Referring to FIG. 8, in operation S420, the receiver may determine whether the magnitude of the first log likelihood ratio is equal to or greater than the magnitude of the second log likelihood ratio.

In operation S511, when the magnitude of the first log likelihood ratio is greater than or equal to the magnitude of the second log likelihood ratio, the receiver may generate the first log likelihood ratio as a final log likelihood ratio.

In operation S512, when the magnitude of the first log likelihood ratio is less than the magnitude of the second log likelihood ratio, the receiver may generate the second log likelihood ratio as a final log likelihood ratio.

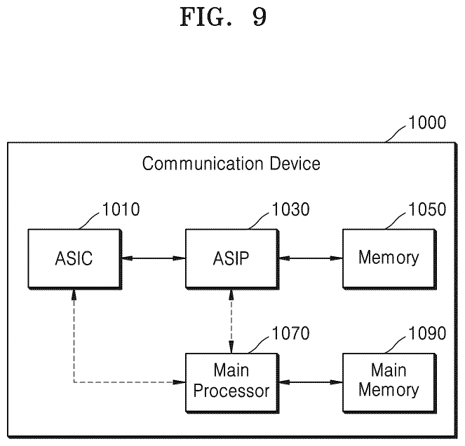

FIG. 9 is a block diagram illustrating a wireless communication device according to embodiments.

Referring to FIG. 9, a wireless communication device 1000 may include an application specific integrated circuit (ASIC) 1010, an application specific instruction set processor (ASIP) 1030, a memory 1050, a main processor 1070, and/or a main memory 1090. Two or more of the ASIC 1010, the ASIP 1030, and the main processor 1070 may communicate with each other. In addition, at least two of the ASIC 1010, the ASIP 1030, memory 1050, the main processor 1070, and the main memory 1090 may be embedded in one chip.

The ASIP 1030 is an integrated circuit customized for a specific purpose, may support a dedicated instruction set for a specific application, and may execute an instruction included in the instruction set. The memory 1050 may communicate with the ASIP 1030 and may store a plurality of instructions executed by the ASIP 1030 as a non-transitory storage device. For example, the memory 1050 may include any type of memory accessible by the ASIP 1030, such as, as non-limiting examples, random access memory (RAM), read only memory (ROM), tape, a magnetic disk, an optical disk, a volatile memory, a non-volatile memory, and a combination thereof.

The main processor 1070 may control the wireless communication device 1000 by executing a plurality of instructions. For example, the main processor 1070 may control the ASIC 1010 and the ASIP 1030, process received data, or process a user's input to the wireless communication device 1000. The main memory 1090 may communicate with the main processor 1070 and store a plurality of instructions executed by the main processor 1070 as a non-transitory storage device. For example, the main memory 1090 may include any type of memory accessible by the main processor 1070, such as, as non-limiting examples, RAM, ROM, tape, a magnetic disk, an optical disk, a volatile memory, a non-volatile memory, and a combination thereof.

The wireless communication device and the method of operating the wireless communication device according to embodiments described with reference to FIGS. 1 to 8 may be performed by at least one of components included in the wireless communication device 1000 of FIG. 9. In embodiments, at least one operation of the method of operating the wireless communication device described above may be implemented as a plurality of instructions stored in the memory 1050. In embodiments, the ASIP 1030 may perform at least one of the operations of the method by executing the plurality of instructions stored in the memory 1050.

Conventional devices and methods for decoding a received signal include generating a log likelihood ratio. However, conventional devices and methods are unable to verify whether the generated log likelihood ratio is accurate with sufficient reliability. Accordingly, the conventional devices and methods are unable to decode the received signal with sufficient accuracy.

However, according to embodiments, improved devices and methods are provided for decoding a received signal. For example, the improved devices and methods may decode the received signal based on two log likelihood ratios generated using different log likelihood ratio calculation methods. The generated log likelihood ratios are compared to determine whether the log likelihood ratios are similar (e.g., have a common sign). In so doing, the improved devices and methods may successfully verify that the decoding of the received signal will be performed accurately using at least one of the generated log likelihood ratios in response to determining the log likelihood ratios are similar. Alternatively, in response to determining the log likelihood ratios are not similar, the improved devices and methods may adjust at least one of the generated log likelihood ratios to improve decoding success probability. For example, the improved devices and methods may decode the received signal based on a log likelihood ratio having a value between those of the generated log likelihood ratios in response to determining the log likelihood ratios are not similar. Accordingly, the improved devices and methods overcome the deficiencies of the conventional devices and methods to least improve decoding accuracy.

According to embodiments, operations described herein as being performed by the communication system 10, the transmitter 100, the receiver 200, the adjustment detector 250, the S/P convertor 110, the multiple CRC units 120_1 to 120_M, the multiple FEC encoders 130_1 to 130_M, the multiple rate matching units 140_1 to 140_M, the multiple modulators 150_1 to 150_M, the multiple layer mapping units 160_1 to 160_M, the precoding unit 170, the multiple IFFT units 180_1 to 180_M, the plurality of FFT units 270_1 to 270_N, the effective channel generating unit 260, the plurality of rate dematching units 240_1 to 240_N, the plurality of FEC decoders 230_1 to 230_N, the plurality of CRC units 220_1 to 220_N, the P/S convertor 210, the adjustment detector 250a, the first detector 251a, the second detector 252a, the log likelihood ratio comparator 253a, the log likelihood ratio adjuster 254a, the adjustment detector 250b, the first detector 251b, the second detector 252b, the log likelihood ratio comparator 253b, the log likelihood ratio adjuster 254b, the wireless communication device 1000, the ASIC 1010, the ASIP 1030 and/or the main processor 1070 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 1050, the main memory 1090, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

While the inventive concepts have been particularly shown and described with reference to embodiments thereof, it will be understood that various changes in form and details may be made therein without departing from the spirit and scope of the following claims.

What is claimed is:

1. A receiver for receiving a signal including a symbol, the receiver comprising:
processing circuitry configured to
generate a first log likelihood ratio corresponding to a bit included in the symbol based on a first log likelihood ratio calculation method, the first log likelihood ratio calculation method being a linear calculation method,
generate a second log likelihood ratio corresponding to the bit based on a second log likelihood ratio calculation method, the second log likelihood ratio calculation method being a nonlinear calculation method,
generate comparison data based on a result of comparing the first log likelihood ratio with the second log likelihood ratio, and
generate a final log likelihood ratio corresponding to at least one of the first log likelihood ratio or the second log likelihood ratio based on the comparison data.

2. The receiver of claim 1, wherein the processing circuitry is configured to generate the comparison data by comparing a sign of the first log likelihood ratio with a sign of the second log likelihood ratio.

3. The receiver of claim 2, wherein the processing circuitry is configured to generate the final log likelihood ratio to be one among the first log likelihood ratio or the second log likelihood ratio based on the sign of the first log likelihood ratio being the same as the sign of the second log likelihood ratio.

4. The receiver of claim 3, wherein the processing circuitry is configured to:
generate the comparison data by comparing a magnitude of the first log likelihood ratio with a magnitude of the second log likelihood ratio; and
generate the final log likelihood ratio a log likelihood ratio having a greater magnitude among the first log likelihood ratio and the second log likelihood ratio.

5. The receiver of claim 2, wherein the processing circuitry is configured to generate the final log likelihood ratio to be a value between the first log likelihood ratio and the second log likelihood ratio based on the sign of the first log likelihood ratio being different from the sign of the second log likelihood ratio.

6. The receiver of claim 5, wherein the processing circuitry is configured to generate the final log likelihood ratio by multiplying any one of the first log likelihood ratio or the second log likelihood ratio by an adjustment value, the adjustment value being less than 1.

7. The receiver of claim 6, wherein the adjustment value decreases as a difference between the first log likelihood ratio and the second log likelihood ratio increases.

8. The receiver of claim 5, wherein the processing circuitry is configured to generate the final log likelihood ratio to be an average of the first log likelihood ratio and the second log likelihood ratio based on the sign of the first log likelihood ratio being different from the sign of the second log likelihood ratio.

9. The receiver of claim 5, wherein the processing circuitry is configured to generate the final log likelihood ratio by:
applying different weights to each of the first log likelihood ratio and the second log likelihood ratio to obtain weighted ratios based on the sign of the first log likelihood ratio being different from the second log likelihood ratio; and
summing the weighted ratios.

10. The receiver of claim 1, wherein
the first log likelihood ratio calculation method is based on a minimum mean square error (MMSE); and
the second log likelihood ratio calculation method is based on a calculation result of the first log likelihood ratio calculation method.

11. A method of operating a receiver, the method comprising:
generating a first log likelihood ratio corresponding to a bit based on a first log likelihood ratio calculation method, the bit being included in a symbol of a received signal;
generating a second log likelihood ratio corresponding to the bit based on a second log likelihood ratio calculation method;
comparing the first log likelihood ratio with the second log likelihood ratio to obtain a comparison result; and
generating a final log likelihood ratio corresponding to at least one of the first log likelihood ratio or the second log likelihood ratio based on the comparison result.

12. The method of claim 11, wherein the comparing of the first log likelihood ratio with the second log likelihood ratio comprises determining whether a sign of the first log likelihood ratio is the same as a sign of the second log likelihood ratio.

13. The method of claim 12, wherein the generating of the final log likelihood ratio comprises generating the final log likelihood ratio to have a magnitude equal to or greater than a magnitude of the first log likelihood ratio and a magnitude of the second log likelihood ratio based on the sign of the first log likelihood ratio being the same as the sign of the second log likelihood ratio.

14. The method of claim 12, wherein
the comparing the first log likelihood ratio with the second log likelihood ratio comprises determining whether a magnitude of the first log likelihood ratio is greater than or equal to a magnitude of the second log likelihood ratio; and
the generating of the final log likelihood ratio includes generating the final log likelihood ratio to be a log likelihood ratio having a greater magnitude among the first log likelihood ratio and the second log likelihood ratio.

15. The method of claim 12, wherein the generating of the final log likelihood ratio includes generating the final log likelihood ratio to be a value between the first log likelihood ratio and the second log likelihood ratio based on the sign of the first log likelihood ratio being different from the sign of the second log likelihood ratio.

16. The method of claim 15, wherein the generating of the final log likelihood ratio comprises generating the final log likelihood ratio by multiplying one among the first log likelihood ratio and the second log likelihood ratio by an adjustment value less than 1.

17. The method of claim 15, wherein the generating of the final log likelihood ratio comprises generating the final log likelihood ratio to correspond to a sum of the first log likelihood ratio and the second log likelihood ratio.

18. A receiver for receiving a signal including a symbol, the receiver comprising:
processing circuitry configured to
generate a first log likelihood ratio and a second log likelihood ratio corresponding to a bit included in a symbol, the first log likelihood ratio and the second log likelihood ratio being generated based on two different log likelihood ratio calculation methods, and
generate a final log likelihood ratio corresponding to at least one of the first log likelihood ratio or the second log likelihood ratio based on a result of comparing the first log likelihood ratio with the second log likelihood ratio, and
decode the symbol based on the final log likelihood ratio.

19. The receiver of claim 18, wherein the processing circuitry is configured to generate the final log likelihood ratio by applying an adjustment value less than 1 to either of the first log likelihood ratio or the second log likelihood ratio based on a sign of the first log likelihood ratio being different from a sign of the second log likelihood ratio.

20. The receiver of claim 18, wherein the processing circuitry is configured to generate the final log likelihood ratio based on a sum of the first log likelihood ratio and the second log likelihood ratio in response to a sign of the first log likelihood ratio being the same as a sign of the second log likelihood ratio.
